(19) United States
(12) Patent Application Publication
(10) Pub. No.: US 2014/0339779 A1
(43) Pub. Date: Nov. 20, 2014

(54) DUSTPROOF MEMBER AND MEASUREMENT DEVICE

(71) Applicant: MITUTOYO CORPORATION, Kawasaki-shi (JP)

(72) Inventors: Kazuhiko Kodama, Utsunomiya-shi (JP); Takanori Otsuka, Utsunomiya-shi (JP); Kazushi Kikuchi, Utsunomiya-shi (JP); Yoshihide Osawa, Hamamatsu-shi (JP); Yusuke Kurosawa, Hamamatsu-shi (JP)

(73) Assignee: MITUTOYO CORPORATION, Kawasaki-shi (JP)

(21) Appl. No.: 14/276,424

(22) Filed: May 13, 2014

(30) Foreign Application Priority Data
May 15, 2013 (JP) 2013-103463

(51) Int. Cl. F16J 15/16

(52) U.S. Cl. CPC F16J 15/16
USPC 277/572

(57) ABSTRACT

A dustproof member for a measurement device is provided. The measurement device includes a frame in which a scale is held and which has an insertion opening that extends in a longitudinal direction, and a detector that is inserted through the insertion opening and capable of moving along the insertion opening in the longitudinal direction to obtain position information from the scale. The dustproof member is provided on the frame to cover the insertion opening of the measurement device. The dustproof member includes a reinforcing member that extends continuously in the longitudinal direction and that is disposed in a substantially central region of the dustproof member in a width direction.

### CROSS REFERENCES TO RELATED APPLICATIONS

The present invention contains subject matter related to Japanese Patent Application No. 2013-103463 filed in the Japan Patent Office on May 15, 2013, the entire contents of which are incorporated herein by reference.

### BACKGROUND OF THE INVENTION

1. Field of the Invention

The present invention relates to a dustproof member and a measurement device.

2. Description of the Related Art

A linear encoder mounted in a machine tool or the like is an example of a measurement device. First, a general structure of a linear encoder will be described. FIG. 1 is a schematic diagram illustrating a general linear encoder. FIG. 5 is a sectional view of the general linear encoder. In the following description, the longitudinal direction, the transverse direction, and the thickness direction of a scale included in the linear encoder are sometimes referred to as the X-axis direction, the Y-axis direction, and the Z-axis direction, respectively, for convenience.

As illustrated in FIGS. 1 and 5, in a general linear encoder, a scale 2 is held in a frame 1, and an insertion opening 1a is formed in the frame 1 so as to extend in the X-axis direction. The scale 2 and a detector 3 are moved relative to each other while the detector 3 is inserted through the insertion opening 1a, and the detector 3 obtains position information from the scale 2 (see, for example, Japanese Unexamined Patent Application Publication No. 2008-267989).

In this structure, to prevent oil, dust including machining dust, etc., from entering the frame 1 through the insertion opening 1a, the frame 1 is provided with dustproof members 101 arranged to face each other across the insertion opening 1a in the Z-axis direction. When the scale 2 and the detector 3 are moved relative to each other, the detector 3 moves along the insertion opening 1a of the frame 1 in the X-axis direction while thrusting the opposing dustproof members 101 aside.

The structure of each dustproof member 101 will now be described. FIG. 6 illustrates a structure of a general dustproof member 101. The length of the dustproof member 101 in the longitudinal direction thereof is substantially equal to the length of the insertion opening 1a of the frame 1 in the X-axis direction. The dustproof member 101 includes a base portion 101a fitted in a fitting recess 1b of the frame 1, and a tongue portion 101b that projects from the base portion 101a.

The dustproof member 101 is generally made of a flexible material, such as urethane, and has a wire 102, made of a metal or synthetic fiber, therein to suppress expansion of the dustproof member 101 in the longitudinal direction due to, for example, absorption of cutting oil or the like. The wire 102 is disposed near the tip portion of the dustproof member 101.

With the general dustproof member 101, since the wire 102 is disposed near the tip portion of the dustproof member 101 as described above, the wire 102 is deformed when, for example, the detector 3 moves along the insertion opening 1a of the frame 1. When the detector 3 moves repeatedly, the wire 102 is repeatedly deformed. Therefore, the tip portion of the dustproof member 101 will eventually be deformed such that it cannot be restored to the original shape, and the quality of the seal between the dustproof member 101 and the detector 3 will be degraded.

### SUMMARY OF THE INVENTION

The present invention has been made to solve the above-described problems, and an object of the present invention is to provide a dustproof member with which deformation due to movement of a detector can be suppressed and a measurement device including the dustproof member.

A dustproof member according to an aspect of the present invention is provided on a frame of a measurement device to cover an insertion opening of the measurement device, the measurement device including the frame, in which a scale is held and the insertion opening is formed in a longitudinal direction of the scale, and a detector that is inserted through the insertion opening and capable of moving along the insertion opening in the longitudinal direction to obtain position information from the scale. The dustproof member includes a reinforcing member that extends continuously in the longitudinal direction and that is disposed in a substantially central region of the dustproof member in a width direction.

In the above-described dustproof member, the reinforcing member is preferably disposed in a substantially central region along a width of the dustproof member.

In the above-described dustproof member, the reinforcing member is preferably disposed substantially at a center of gravity of the dustproof member in cross section of the dustproof member.

In the above-described dustproof member, the reinforcing member is preferably disposed in a substantially central region in a thickness direction of the dustproof member.

In the above-described dustproof member, the reinforcing member is preferably a stranded wire made of a metal or synthetic fiber.

A measurement device according to another aspect of the present invention includes the above-described dustproof member.

The present invention provides a dustproof member with which deformation due to movement of a detector can be suppressed and a measurement device including the dustproof member.

### BRIEF DESCRIPTION OF THE DRAWINGS

FIG. 1 is a schematic perspective view of a general linear encoder.

FIG. 2 is a schematic sectional view of a dustproof member according to an embodiment.

FIG. 3 is a schematic sectional view illustrating the manner in which dustproof members according to the embodiment cover an insertion opening of a frame in a region where a detector is not inserted through the insertion opening.

FIG. 4 is a schematic sectional view illustrating the manner in which the dustproof members according to the embodiment cover the insertion opening of the frame in a region where the detector is inserted through the insertion opening.

FIG. 5 is a schematic sectional view of a general linear encoder.

FIG. 6 is a schematic sectional view of a general dustproof member.

### DESCRIPTION OF THE PREFERRED EMBODIMENTS

An embodiment of the present invention will now be described with reference to the drawings. However, the present invention is not limited to the embodiment. To facilitate understanding, the following description and drawings are simplified as appropriate.

First, the basic structure of a measurement device in which dustproof members of the present embodiment are incorporated will be described. The dustproof members of the present embodiment are incorporated in a linear encoder, which is a typical example of a measurement device. The dustproof members of the present embodiment may instead be incorporated in a measurement device other than the linear encoder.

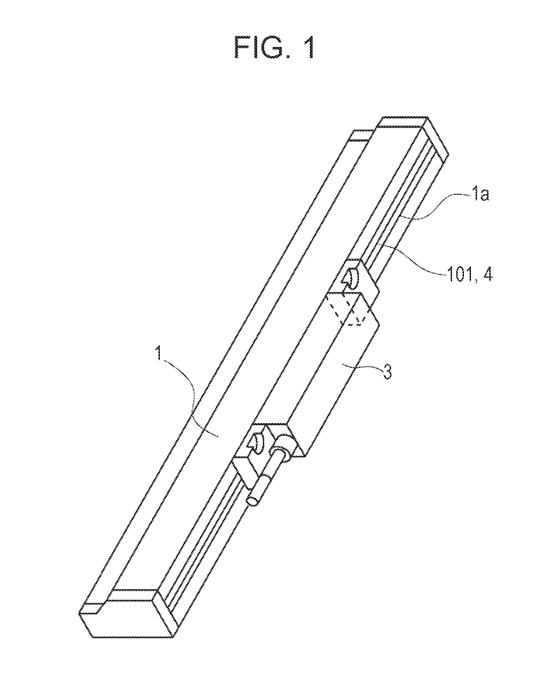

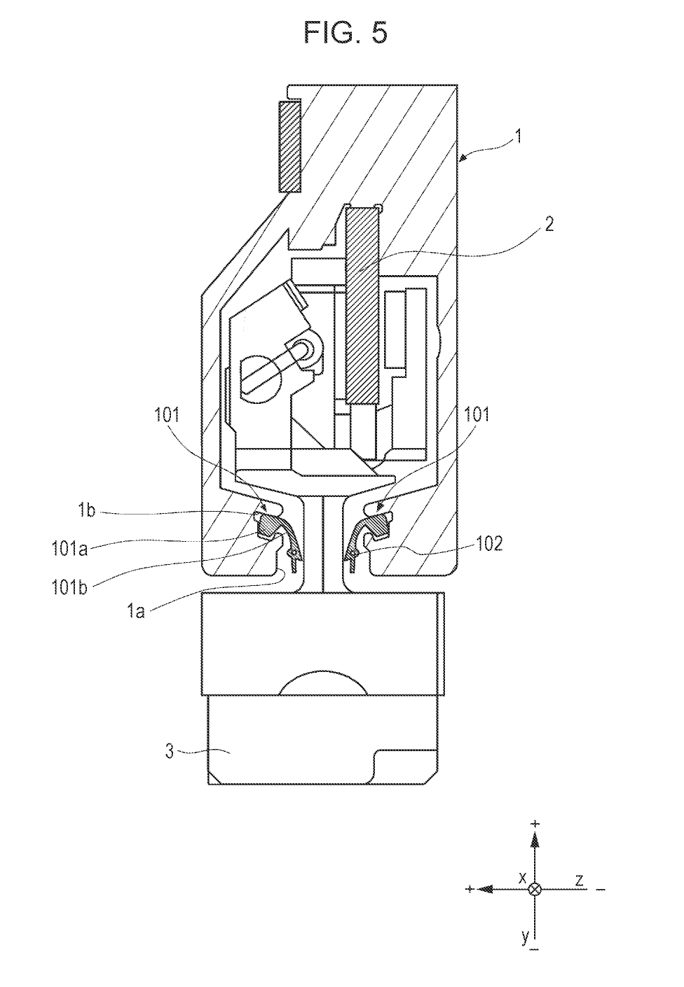

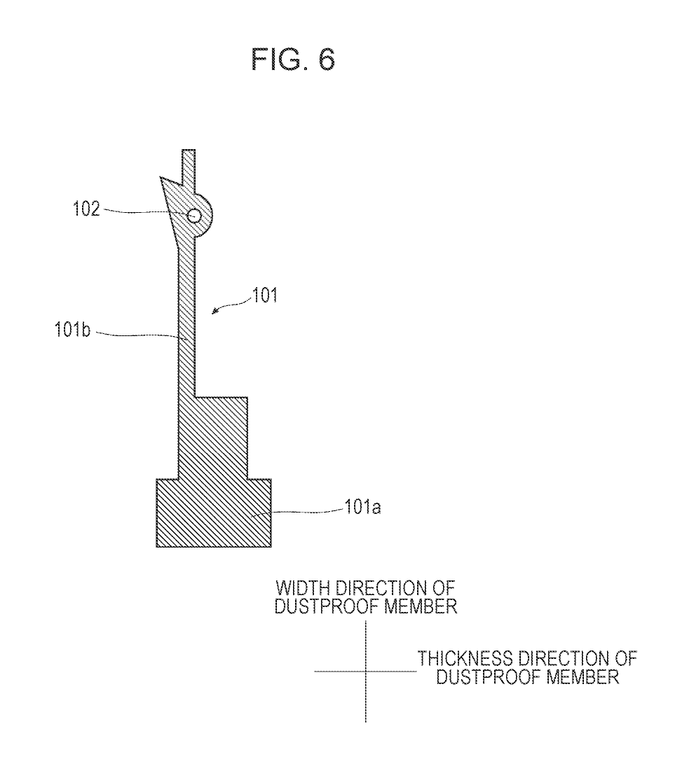

Although a structure of a linear encoder has been described above in the Background of the Invention section, it will be briefly described again with reference to FIGS. 1 and 5. As illustrated in FIGS. 1 and 5, in a general linear encoder, a scale 2 is held in a frame 1 and an insertion opening 1a is formed in the frame 1 so as to extend in the X-axis direction. The scale 2 and a detector 3 are moved relative to each other while the detector 3 is inserted through the insertion opening 1a, and the detector 3 obtains position information from the scale 2.

In this structure, as described above, it is necessary to employ a dustproof structure to prevent dust and the like from entering the frame 1 through the insertion opening 1a. The dustproof members of the present embodiment are incorporated in the dustproof structure.

The scale 2 may be, for example, an optical scale or an electromagnetic induction scale for a general linear encoder. The detector 3 is configured to be capable of obtaining the position information from the scale 2.

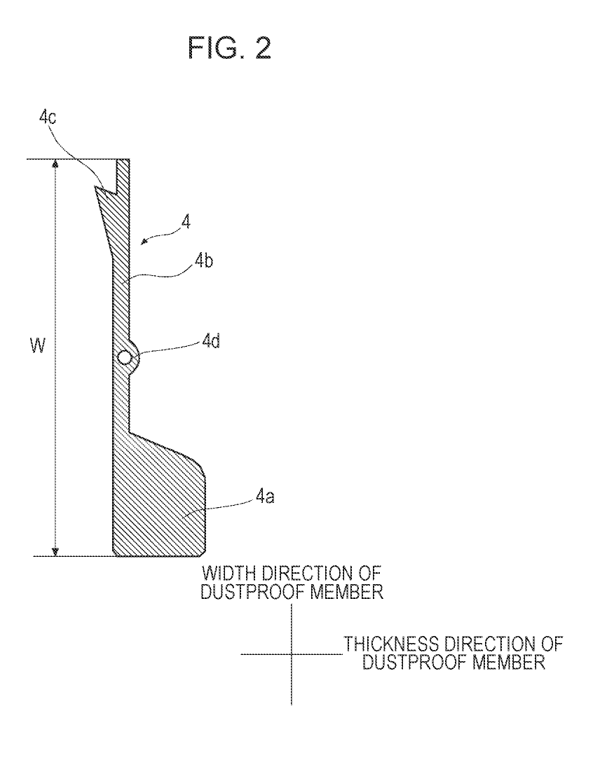

The structure of the dustproof members according to the present embodiment will now be described. FIG. 2 illustrates the structure of each dustproof member 4. The dustproof member 4 includes a base portion 4a, a tongue portion 4b, a projecting portion 4c, and a reinforcing member 4d. The base portion 4a, the tongue portion 4b, and the projecting portion 4c are integrally formed of a flexible material, such as urethane, nitrile butadiene rubber (NBR), or fluorocarbon rubber, so that the reinforcing member 4d is disposed therein.

The length of the base portion 4a in the longitudinal direction is substantially equal to the length of the insertion opening 1a of the frame 1 in the X-axis direction. The base portion 4a is formed in a shape that corresponds to the shape of fitting recesses 1b formed in the frame 1, and is fitted in the corresponding fitting recess 1b of the frame 1. The shape of the base portion 4a is not particularly limited as long as the dustproof member 4 can be supported by the corresponding fitting recess 1b of the frame 1.

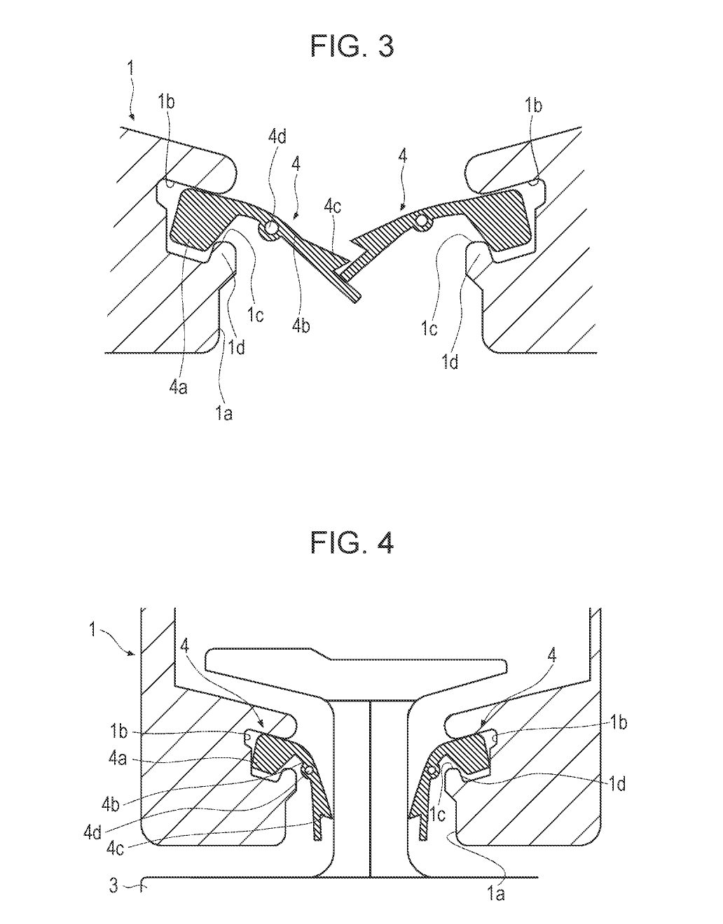

As illustrated in FIGS. 3 and 4, the fitting recesses 1b of the frame 1 are arranged so as to face each other across the insertion opening 1a of the frame 1 in the Z-axis direction. Each fitting recess 1b has a substantially rectangular shape when viewed in the X-axis direction, and has an opening 1c that faces the insertion opening 1a. The shape of the fitting recesses 1b is not limited as long as the base portions 4a of the dustproof members 4 can be appropriately fitted in the fitting recesses 1b.

The opening 1c of each fitting recess 1b in the frame 1 is partially covered by a side wall 1d that projects in the positive Y-axis direction from the fitting recess 1b at a position near the insertion opening 1a. The side wall 1d is preferably curved at the tip thereof so as not to damage the corresponding dustproof member 4 even when the dustproof member 4 comes into contact therewith.

With regard to each dustproof member 4, the tongue portion 4b is formed so as to extend over substantially the entirety of the base portion 4a in the longitudinal direction, and is a plate-shaped member that projects from the base portion 4a. The length of the tongue portion 4b in the transverse direction (width direction), which will be described in detail below, is set so that the insertion opening 1a of the frame 1 can be reliably covered by the opposing dustproof members 4.

The projecting portion 4c is formed so as to extend over substantially the entirety of the tongue portion 4b in the longitudinal direction. The projecting portion 4c, which will be described in detail below, projects from a surface of the tongue portion 4b at a position near the tip of the tongue portion 4b, the surface coming into contact with the dustproof member 4 that faces the tongue portion 4b. The function of the projecting portion 4c will be described below.

The reinforcing member 4d reinforces the dustproof member 4. The reinforcing member 4d is preferably a wire made of a metal or synthetic fiber, such as aramid. In particular, the reinforcing member 4d is preferably a stranded wire made of a metal or synthetic fiber, such as aramid. In such a case, adhesion between the material of the reinforcing member 4d and the flexible material can be increased when they are integrated together.

The reinforcing member 4d is formed over the entirety of the dustproof member 4 in the longitudinal direction. The reinforcing member 4d is disposed at least in a substantially central region of the dustproof member 4 in the width direction. More specifically, the reinforcing member 4d is located so that the reinforcing member 4d is not easily deformed due to movement of the detector 3 when the detector 3 is moved along the frame 1. Therefore, even when the detector 3 is repeatedly moved along the frame 1, deformation of the reinforcing member 4d is suppressed. Consequently, deformation of the tip portion of the dustproof member 4 due to the movement of the detector 3 can be suppressed, and the quality of the seal between the dustproof member 4 and the detector 3 can be improved.

Moreover, both end portions of the dustproof member 4 in the width direction have substantially the same deformation characteristics, and difference in, for example, the amount of expansion in the longitudinal direction due to absorption of cutting oil or the like between both end portions of the dustproof member 4 in the width direction can be reduced. Consequently, twisting and warping of the dustproof member 4 can be suppressed.

In particular, in the case where the dustproof member 4 is manufactured by extrusion by using fluorocarbon rubber, only one reinforcing member 4d may be placed in the dustproof member 4 according to the manufacturing method. In this case, compared to the case in which a wire is placed in an end portion of the dustproof member 4 in the width direction, the distance between the reinforcing member 4d and each end portion of the dustproof member 4 in the width direction can be reduced. Accordingly, both end portions of the dustproof member 4 in the width direction have substantially the same deformation characteristics, and twisting and warping of the dustproof member 4 can be suppressed.

In addition, even when thermal contraction occurs in the extrusion process, since both end portions of the dustproof member 4 in the width direction have substantially the same deformation characteristics, twisting and warping of the dustproof member 4 can be suppressed.

The reinforcing member 4d may be disposed in a substantially central region of the dustproof member 4 along the width W of the dustproof member 4 or substantially at the center of gravity of the dustproof member 4 in cross section of the dustproof member 4.

The reinforcing member 4d is preferably disposed in a substantially central region of the dustproof member 4 in the thickness direction. In the present embodiment, the reinforcing member 4d is disposed in a substantially central region of the tongue portion 4b in the thickness direction, and a portion around the reinforcing member 4d is made thicker. Thus, the reinforcing member 4d is reliably covered, and the possibility that the reinforcing member 4d will be cut by machining dust or the like can be reduced.

An example in which the dustproof members 4 of the present embodiment are installed in a dustproof structure of a linear encoder will now be described. FIG. 3 illustrates the manner in which the opposing dustproof members 4 cover the insertion opening 1a of the frame 1 in a region where the detector 3 is not inserted. FIG. 4 illustrates the manner in which the opposing dustproof members 4 cover the insertion opening 1a of the frame 1 in a region where the detector 3 is inserted.

As illustrated in FIGS. 3 and 4, the base portions 4a of the above-described dustproof members 4 are fitted in the respective fitting recesses 1b of the frame 1 so that the tongue portions 4b project from the openings 1c of the fitting recesses 1b.

In the region where the detector 3 is not inserted through the insertion opening 1a of the frame 1, the tip portions of the dustproof members 4, which are arranged so as to face each other in the Z-axis direction, contact each other to close the insertion opening 1a of the frame 1 in such a state that the dustproof members 4 are warped, that is, the tip portion of each dustproof member 4 is pivotally deformed in the negative Y-axis direction.

In the present embodiment, as illustrated in FIG. 3, the tip portions of the dustproof members 4 are engaged with each other owing to the projecting portions 4c of the dustproof members 4, and the dustproof members 4 are maintained in the warped state. Accordingly, each dustproof member 4 exerts a restoring force in a direction such that the other dustproof member 4 is pushed. Therefore, even when the tip portion of one of the dustproof members 4 tries to be pivotally deformed in the negative Y-axis direction to change the state of the tip portions of the dustproof members 4 from the closed state to an open state, the dustproof member 4 is restrained by the restoring force thereof. Therefore, dust and the like can be prevented from entering the frame 1.

In the region where the detector 3 is inserted through the insertion opening 1a of the frame 1, the tip portions of the dustproof members 4, which are arranged so as to face each other in the Z-axis direction, sandwich the detector 3 to close the insertion opening 1a of the frame 1 in such a state that the dustproof members 4 are warped.

In the present embodiment, as illustrated in FIG. 4, the projecting portions 4c of the dustproof members 4 are in contact with the detector 3, and the dustproof members 4 are maintained in the warped state. Accordingly, each dustproof member 4 exerts a restoring force in a direction such that the detector 3 is pushed. Therefore, even when the tip portion of one of the dustproof members 4 tries to be pivotally deformed in the negative Y-axis direction to change the state of the tip portion of the dustproof member 4 and the detector 3 from the closed state to an open state, the dustproof member 4 is restrained by the restoring force thereof. Therefore, dust and the like can be prevented from entering the frame 1.

The present invention is not limited to the above-described embodiment, and appropriate modifications are possible within the scope of the present invention.

What is claimed is:

1. A dustproof member provided on a frame of a measurement device to cover an insertion opening of the measurement device, the measurement device including the frame, in which a scale is held and the insertion opening is formed in a longitudinal direction of the scale, and a detector that is inserted through the insertion opening and capable of moving along the insertion opening in the longitudinal direction to obtain position information from the scale, the dustproof member comprising:
a reinforcing member that extends continuously in the longitudinal direction and that is disposed in a substantially central region of the dustproof member in a width direction.

2. The dustproof member according to claim 1, wherein the reinforcing member is disposed in a substantially central region along a width of the dustproof member.

3. The dustproof member according to claim 1, wherein the reinforcing member is disposed substantially at a center of gravity of the dustproof member in cross section of the dustproof member.

4. The dustproof member according to claim 1, wherein the reinforcing member is disposed in a substantially central region in a thickness direction of the dustproof member.

5. The dustproof member according to claim 2, wherein the reinforcing member is disposed in a substantially central region in a thickness direction of the dustproof member.

6. The dustproof member according to claim 3, wherein the reinforcing member is disposed in a substantially central region in a thickness direction of the dustproof member.

7. The dustproof member according to claim 1, wherein the reinforcing member is a stranded wire made of a metal or synthetic fiber.

8. The dustproof member according to claim 2, wherein the reinforcing member is a stranded wire made of a metal or synthetic fiber.

9. The dustproof member according to claim 3, wherein the reinforcing member is a stranded wire made of a metal or synthetic fiber.

10. The dustproof member according to claim 4, wherein the reinforcing member is a stranded wire made of a metal or synthetic fiber.

11. The dustproof member according to claim 5, wherein the reinforcing member is a stranded wire made of a metal or synthetic fiber.

12. The dustproof member according to claim 6, wherein the reinforcing member is a stranded wire made of a metal or synthetic fiber.

13. A measurement device comprising the dustproof member according to claim 1.

14. A measurement device comprising the dustproof member according to claim 2.

15. A measurement device comprising the dustproof member according to claim 3.

16. A measurement device comprising the dustproof member according to claim 4.

17. A measurement device comprising the dustproof member according to claim 5.

18. A measurement device comprising the dustproof member according to claim 6.

19. A measurement device comprising the dustproof member according to claim 7.

20. A measurement device comprising the dustproof member according to claim 8.

21. A measurement device comprising the dustproof member according to claim 9.

22. A measurement device comprising the dustproof member according to claim 10.

23. A measurement device comprising the dustproof member according to claim 11.

24. A measurement device comprising the dustproof member according to claim 12.
